(19) United States
(12) Patent Application Publication
(10) Pub. No.: US 2009/0125345 A1
(43) Pub. Date: May 14, 2009

(54) METHOD OF DERIVING A BUSINESS PROCESS FROM A SET OF PATHS

(75) Inventor: Andreas Schmitz, Tuebingen (DE)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/938,879

(22) Filed: Nov. 13, 2007

(51) Int. Cl. G06Q 10/00

(52) U.S. Cl. 705/7

(57) ABSTRACT

A method of deriving a business process from a set of paths including modeling a set of discrete paths within a set of activities, building a matrix including first through i columns, i being equal to a number of discrete paths within the set of identified discrete paths, and first through j rows, j being equal to or greater than a number of activities in the discrete path having the largest number of activities therein, each element of each row being either empty or representative of a common activity, searching for at least one discrete path within the matrix, and generating an implementation of the business process according to the presence of the at least one discrete path.

### BACKGROUND OF THE INVENTION

1. Field of the Invention

Aspects of the present invention relate to a method of deriving a business process from a set of paths and, more particularly, to a method of deriving a business process from a set of paths expressed in a matrix.

2. Description of the Background

In many business environments, the ability of a business to organize itself is vital to the survival of the business. However, given the level of complexity of most modern businesses and the fluid nature of most business processes, high levels of organization can be difficult to achieve.

For example, within one unit of a business a single manager might have several business processes for which he is responsible and each of those business processes might have several sub-processes that are themselves divisible into even smaller activities. The ability to describe each of those activities, sub-processes and business processes in, for example, a complete picture would seem to increase the manager's productivity and simultaneously decrease the likelihood that sub-processes or process operations will be overlooked. However, within this example and, especially in the context of larger businesses, the complete picture is often very complex and more confusing than helpful. Furthermore, it is generally impossible to interact with the information contained within the complete picture.

### SUMMARY OF THE INVENTION

In accordance with an embodiment of the invention, a method of deriving a business process from a set of paths is provided. The method comprises defining a set of activities related to the business process, each activity being one of an initial operation, an intervening operation, an ending operation, or a standalone operation, modeling a set of discrete paths within the set of the activities, each discrete path including one of an initial operation and an ending operation, an initial operation, an ending operation and at least one intervening operation, or a standalone operation, identifying common activities, building a matrix including first through i columns, i being equal to a number of discrete paths within the set of identified discrete paths, and first through j rows, j being equal to or greater than a number of activities in the discrete path having the largest number of activities therein, each element of each row being either empty or representative of one of the identified common activities, searching for at least one discrete path, which matches defined path criteria, within the matrix to determine a presence of the at least one discrete path; and generating an implementation of the business process according to the presence of the at least one discrete path. If the at least one discrete path includes a number of plural discrete paths, the method further comprises repeating the searching and the generating operations until the number of plural discrete paths is reduced to a predetermined threshold

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTIONS OF THE DRAWINGS

The subject matter regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIGS. 1A, 1B and 1C are schematic diagrams of a set of activities related to a business process, a matrix generated from the set of activities, and an implementation generated from the matrix, respectively, according to exemplary embodiments of the invention; and

FIG. 2 is a flow diagram of a method of deriving the business process according to an exemplary embodiment of the invention.

### DETAILED DESCRIPTION OF THE INVENTION

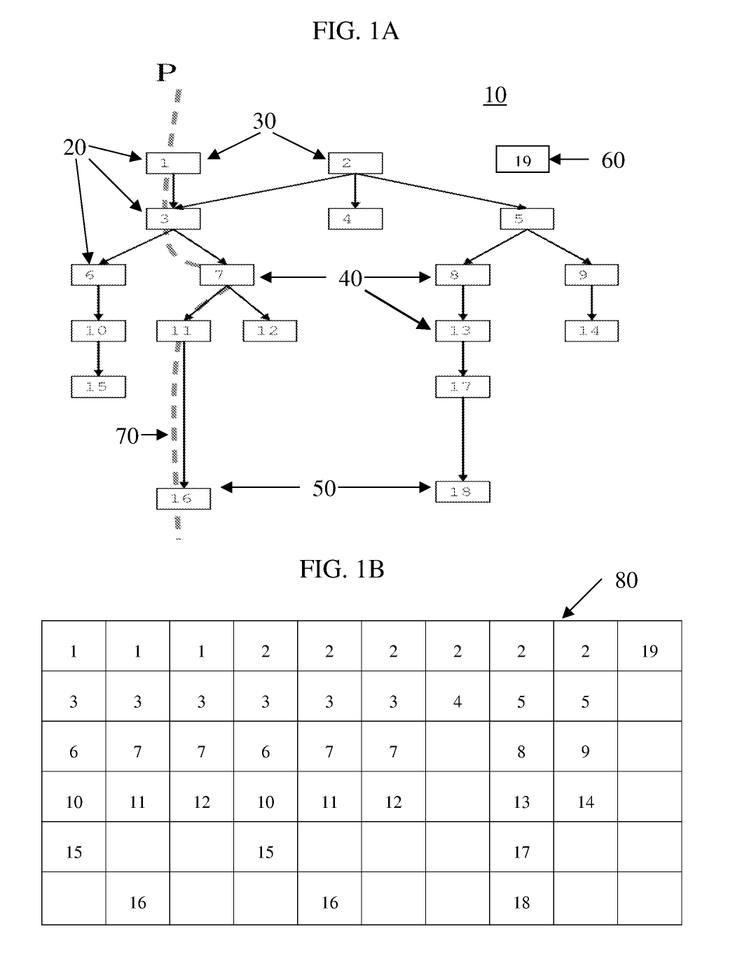

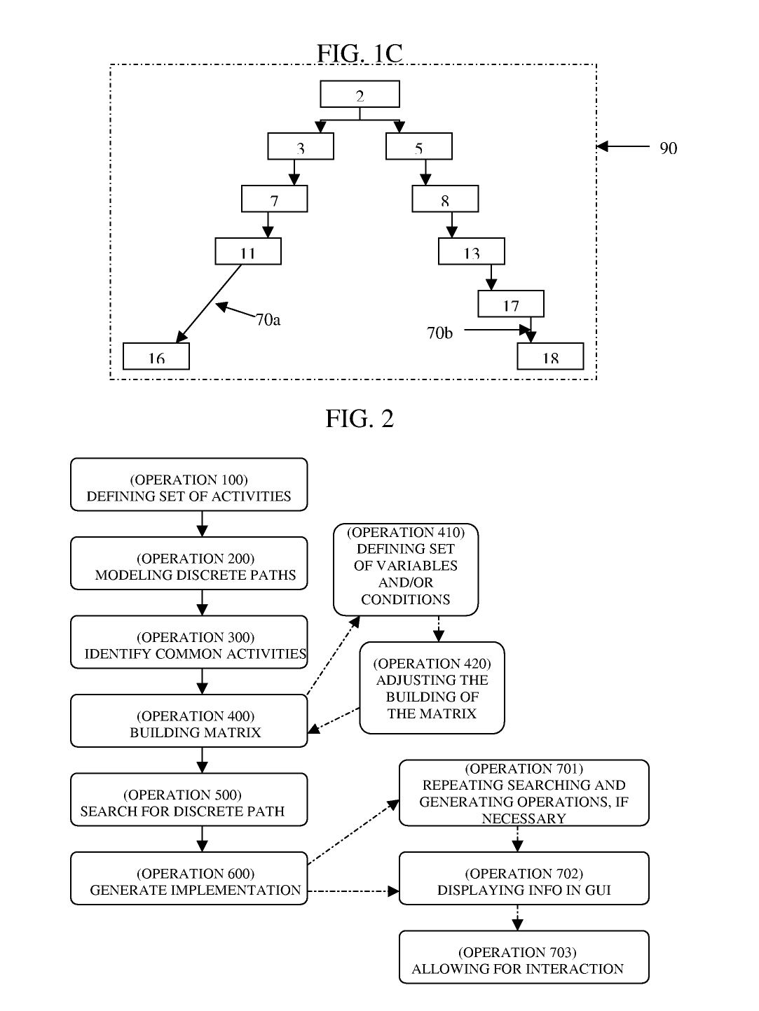

With reference to FIGS. 1A, 1B and 1C, a method of deriving a business process 10 from a set of paths initially comprises defining a set of activities 20 that are related to the business process (operation 100 of FIG. 2). As an example, in practice, the business process 10 may include activities 20, such as receiving a customer request, gaining approval and replying to the customer.

As shown in FIG. 1A, each activity 20 is one of an initial operation 30, which is succeeded by at least one successor activity and which is not preceded by a predecessor activity, an intervening operation 40, which is succeeded by at least one successor activity and which is preceded by at least one predecessor activity, an ending operation 50, which is not succeeded by a successor activity and which is preceded by at least one predecessor activity, or a standalone operation 60, which is not succeeded or preceded by another activity.

A set of discrete paths 70 within the set of the activities 20 is then identified (operation 200 of FIG. 2). Each discrete path 70 may be defined as a path P through the business process 10 for which a sequence of activities may be sequentially navigated. That is, for each activity 20 in P, exactly one predecessor (if a predecessor exists) and exactly one successor (if a successor exists) is also contained in P. In detail, with reference to FIG. 1A, the path P includes beginning activity 1, which acts as an initial operation 30, proceeds through activities 3, 7 and 11, which act as intervening operations 40, and ends with succeeding activity 16, which acts as an ending operation 50. As such, it may be generally stated that each discrete path 70 includes one of a first combination of an initial operation 30 and an ending operation 50, a second combination of an initial operation 30, an ending operation 50 and at least one intervening operation 40, or a standalone operation 60.

Activities 20 which are common to various discrete paths 70 are then identified (operation 300 of FIG. 2). The common activities 20 may be an activity 20, which is actually repeated in various discrete paths 70. Alternatively, common activities 20 may be a set of activities 20, which are similar to one another. That is, in the business process 10 of FIG. 1, activity 2 is the initial operation 30 of six discrete paths 70 and is, therefore, common to those discrete paths 70. Likewise, activities 16 and 18, which each act as ending operations 50 for their respective discrete paths 70, are similar to one another and are, therefore, also identified as common.

A matrix 80 is then built (operation 400 of FIG. 2) based upon the set of the identified discrete paths 70 in view of a presence of the identified common activities 20. The matrix 80 includes first through i columns, i being equal to a number of discrete paths 70 within the set of identified discrete paths 70, and first through j rows, j being equal to or greater than a number of activities in each path 70 having the largest number of activities 20 therein. Each element of each row is either empty or representative of the identified common activities 20. That is, exemplary element (5, 5) is empty while element (8, 5) is representative of activity 17. Likewise, exemplary elements (5, 6) and (8, 6) are representative of activities 16 and 18, respectively, which are common with respect to one another.

Referring now to FIG. 1C, the matrix 80 may then be searched for at least one discrete path 70, which matches defined path criteria, to determine a presence of the at least one discrete path 70 (operation 500 of FIG. 2). Subsequent to the search, an implementation, such as the exemplary implementation 90 of the business process 10 shown in FIG. 1C, is then generated from the search of the matrix 80 (operation 600 of FIG. 2). As shown, the generating of the implementation operation 600 can be employed to determine a presence of any discrete paths 70 that match the defined path criteria. That is, in an example embodiment, activity 2 is assumed to represent the receiving of a customer request and activities 16 and 18 represent replying to the customer via email and fax, respectively. Here, a search for a discrete path 70 through business process 10, including an initial operation 30 of receiving a customer request and an ending operation 50 of replying to the customer, would return discrete path 70a including activities 2, 3, 7, 11 and 16 and discrete path 70b including activities 2, 5, 8, 13, 17 and 18.

With further reference to FIG. 1C, where, if the at least one discrete path 70 includes a number of plural discrete paths (i.e., discrete paths 70a and 70b), embodiments of the invention may further comprise repeating the searching and the generating operations until the number of plural discrete paths is reduced to a predetermined threshold (operation 701 of FIG. 2). In the example of FIG. 1C, a further search might specify that the desired discrete path 70 have the least number of activities therein. Here, the secondary search would return only discrete path 70a.

With reference now to FIG. 2, in accordance with further embodiments of the invention, the generating of the matrix may further comprise defining a set of variables and/or conditions that may affect the order of activities within certain discrete paths (operation 410) and adjusting the building of the matrix in accordance with the variables and/or the conditions (operation 420).

With further reference to FIG. 2, in accordance with still further embodiments of the invention, information contained within the matrix and the implementation may be displayed in a graphical user interface (GUI) (operation 702), and a user may interact with the GUI (operation 703). For example, where a second matrix (not shown) is generated which associates each operation of matrix 80 with a cost value, the matrix 80 and the second matrix could be mathematically compared to determine the costs of each path 70.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

1. A computer implemented method of deriving a business process from a set of paths comprising:
defining a set of activities related to the business process, each activity being one of an initial operation, an intervening operation, an ending operation, or a standalone operation;
modeling a set of discrete paths within the set of the activities, each discrete path including one of:
an initial operation and an ending operation,
an initial operation, an ending operation and at least one intervening operation, or
a standalone operation;
identifying common activities in various discrete paths as being activities which are repeated in various discrete paths or activities in discrete paths which are similar to one another;
building a first matrix including first through i columns, i being equal to a number of discrete paths within the set of identified discrete paths, and first through j rows, j being equal to or greater than a number of activities in the discrete path having the largest number of activities therein, each element of each particular row being either empty or representative of a same one of the identified common activities;
defining a set of variables and/or conditions which affect the order of activities within certain discrete paths and adjusting the first matrix in accordance with the variables and/or the conditions;
building a second matrix, which associates each element of the first matrix with a cost value, and mathematically comparing the second matrix with the first matrix to determine a cost of each of the discrete paths;
displaying information contained within the adjusted first matrix and the second matrix to a user via a graphical user interface (GUI) with which the user interacts;
identifying a first set of user defined path criteria;
allowing the user to search for at least one discrete path via the GUI, which matches the user defined path criteria, within the displayed information of the adjusted first matrix to determine a presence of the at least one discrete path;
identifying a second set of user defined path criteria;
allowing the user to repeat the search within the displayed information of the adjusted first matrix via the GUI until a number of discrete paths matching the first and second sets of user defined path criteria is reduced; and
where a search and a repeated search by the user are each conducted, displaying a result of the searching and the repeated searching via the GUI from which an implementation of the business process is derived.

2-4. (canceled)
